(19) United States
(12) Patent Application Publication
(10) Pub. No.: US 2004/0259424 A1
(43) Pub. Date: Dec. 23, 2004

(54) Electronic apparatus with connectors

(76) Inventors: Mitsuyoshi Tanimoto, Sagamihara-shi (JP); Kohei Wada, Fussa-shi (JP); Toshikatsu Nakamura, Akishima-shi (JP); Masayasu Tokuoka, Kadaira-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/819,576

(22) Filed: Apr. 6, 2004

(30) Foreign Application Priority Data
Jun. 17, 2003 (JP) 2003-172371

(51) Int. Cl. H01R 13/62

(52) U.S. Cl. 439/660

(57) ABSTRACT

An electronic apparatus includes a housing provided with first and second connectors, a first fixing member receiving element positioned on the side of the first connector opposite to the second connector side, a second fixing member receiving element positioned on the side of the second connector opposite to the first connector side, and a third fixing member receiving element positioned between the first connector and the second connector. First and second plugs are removably connected to the first and second connectors. The first fixing member receiving element fixes one fixing member of the first plug. The second fixing member receiving element fixes one fixing member of the second plug. The third fixing member receiving element fixes either the other fixing member of the first plug or the other fixing member of the second plug.

### CROSS-REFERENCE TO RELATED APPLICATIONS

This application is based upon and claims the benefit of priority from the prior Japanese Patent Application No. 2003-172371, filed Jun. 17, 2003, the entire contents of which are incorporated herein by reference.

### BACKGROUND

1. Field

The present invention is related to an electronic apparatus, in particular to the structure for connecting external apparatuses to the electronic apparatus.

2. Description of the Related Art

A portable computer referred to as a notebook comprises a main unit including a keyboard, and a liquid crystal display unit supported by the main unit. The main unit includes a flat, box-like housing. A plurality of connectors are placed in a line at a side surface of the housing to permit connection of external apparatuses having the same function but different types of connecting portions.

Japanese Patent Application KOKAI Publication No. 7-28559 discloses such a portable computer wherein the connectors are covered to prohibit external apparatuses having the same function from being concurrently connected to the housing, and the connector covers provided to the housing permit one of the connectors to be selectively exposed.

There is a kind of plug that is used by connecting the plug body to a connector and securing the plug body to the housing by screws. Such a plug comprises a casing, a plug body, and a pair of screws provided on both sides of the plug body, and the plug body and the pair of screws are contained in the casing.

When such a plug is to be used, it is necessary to provide the housing with screw bosses on both sides of a connector. Therefore, between two adjacent connectors, a screw boss belonging to one connector and a screw boss belonging to the other connector are placed side by side. In addition, it is necessary to place adjacent connectors with a sufficient space in between to prevent the casings of plugs, respectively corresponding to the connectors, from interfering with each other when they are concurrently connected.

However, in regard to a portable computer, there is an instance where adjacent connectors are not used concurrently, such as adjacent connectors for connection of a plurality of external apparatuses having the same function but different types of connecting portions. In such an instance, these connectors do not need to be placed with a sufficient space to allow concurrent connection of their respective corresponding plugs as stated above.

Also, there is a demand for further downsizing and functional advancement of portable computers, and it is desirable that various components contained in a housing be placed at a high density. Therefore, there is a demand for reduction of the space occupied by such connectors as those that are placed adjacent to each other but are not used concurrently.

### BRIEF DESCRIPTION OF THE SEVERAL VIEWS OF THE DRAWING

FIG. 1 is a perspective view showing a portable computer according an embodiment of the present invention;

FIG. 2 is an exemplary rear view showing the portable computer of FIG. 1;

FIG. 3 is a top view showing part of the portable computer of FIG. 1 and part of a first connector cable;

FIG. 4 is a top view showing the state where the first connector, part of which is omitted, is connected to the portable computer, part of which is omitted, of FIG. 1; and

FIG. 5 is a top view showing the state where a second connector is connected to the portable computer of FIG. 1.

### DETAILED DESCRIPTION

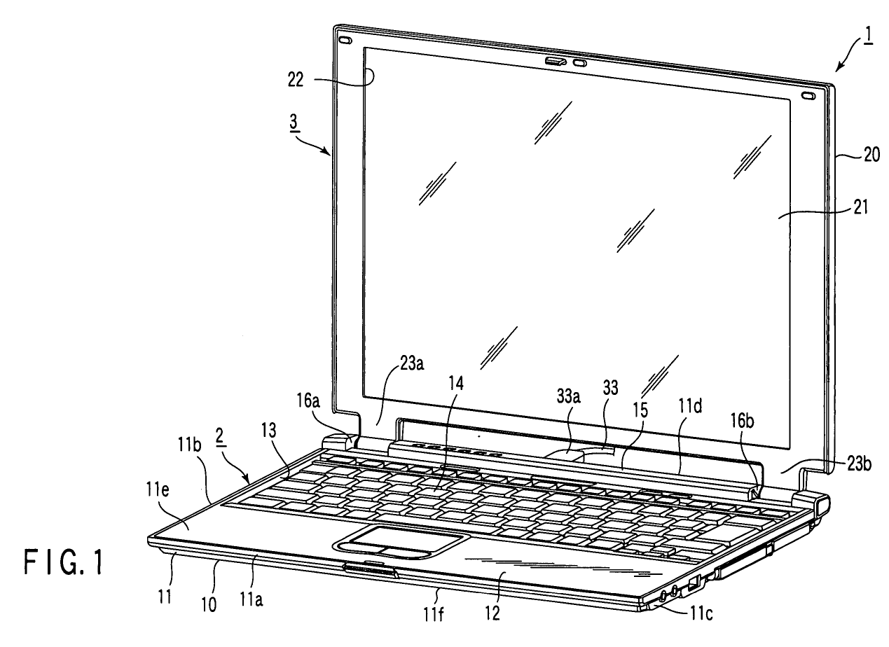

An embodiment of the present invention will now be described with reference to FIGS. 1 to 5, wherein the present invention is applied to any electronic apparatus featuring two connectors, such as a portable computer. A portable computer 1 comprises a main unit 2 and a liquid crystal display unit 3 supported by the main unit 2.

The main unit 2 includes a housing 10, which is placed on a footprint (not shown) that is like, for example, the top of a desk. The housing 10 comprises a front wall 11a, right and left side walls 11b, 11c, a connector panel 11d that also serves as a rear wall, a top wall 11e, and a bottom wall 11f, and is shaped like a flat box.

The top wall 11e includes a palm rest 12 and a keyboard mounting portion 13. The palm rest 12 extends in the width direction of the housing 10 in the front half of the housing 10. The keyboard mounting portion 13 is positioned behind the palm rest 12. A keyboard 14 is mounted to the keyboard mounting portion 13.

At a rear end portion of the top wall 11e, a slender projecting portion 15 that juts upward is formed. The slender projecting portion 15 extends over the entire width of the housing 10 behind the keyboard 14. The rear end edge of the slender projecting portion 15 is continuous with the upper end edge of the connector panel 11d. In addition, the slender projecting portion 15 includes a pair of display supporting portions 16a, 16b. Each of the display supporting portions 16a, 16b comprises a depression opening frontward, upward and rearward of the slender projecting portion 15. These display supporting portions 16a, 16b are spaced apart from each other in the longitudinal direction of the slender projecting portion 15.

The liquid crystal display unit 3 comprises a display housing 20, and a liquid crystal panel 21 contained in the display housing 20. An opening 22 for display is formed in the front wall of the display housing 20. The opening 22 has a size equivalent to a majority of the front wall. The screen of the liquid crystal panel 21 is exposed to the outside of the display housing 20 through the opening 22.

The display housing 20 includes a pair of leg portions 23a, 23b at one end portion. The leg portions 23a, 23b are spaced part from each other in the width direction of the display housing 20, and respectively extend to the display supporting portions 16a, 16b of the housing 10. These leg portions 23a, 23b are rotatably supported by the rear end portion of the housing 10 via respective hinge members (not shown).

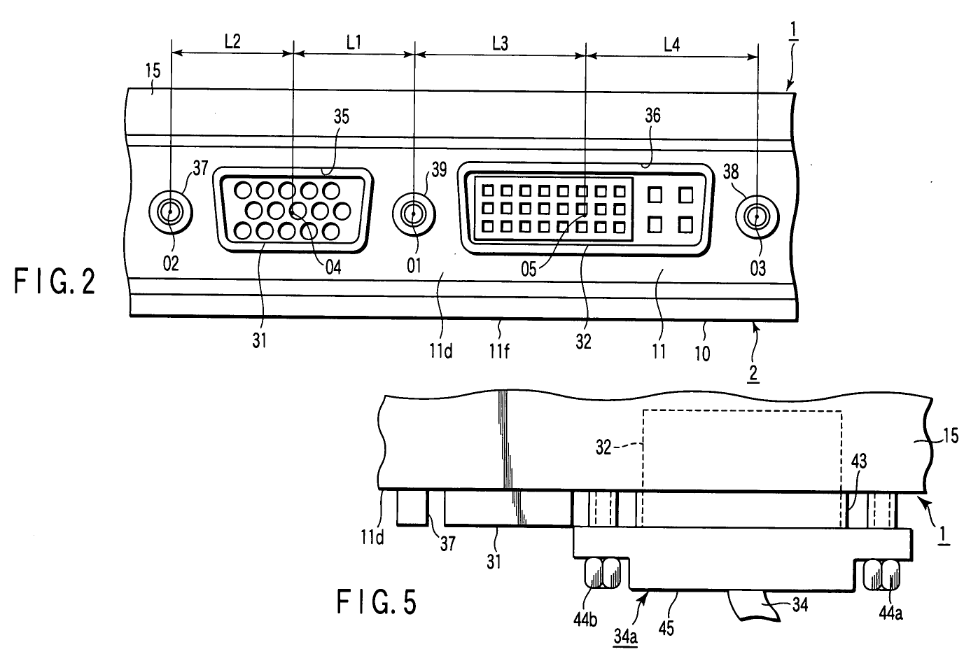

Thus, the liquid crystal display unit 3 is rotatable between a closed position in which the liquid crystal display unit 3 is tilted to cover the palm rest 12 and the keyboard 14 from the above, and an open position in which the liquid crystal display unit 3 is stood up to expose the palm rest 12 and the keyboard 14. FIG. 1 shows the portable computer 1 in the closed position. FIG. 2 shows the portable computer 1 in the open position.

A printed wiring board (not shown) is contained in the housing 10. The printed wiring board is placed below the keyboard 14 and is secured to the bottom wall 11f of the housing 10 with screws.

As shown in FIGS. 2 to 5, the first connector 31 and the second connector 32 are provided to the housing 10. The first connector 31 and the second connector 32 are mounted to the connector panel 11d such that they are adjacent to each other. In FIGS. 2 to 5, the first connector 31 is located on the left of the second connector 32. In other words, in FIGS. 2 to 5, the second connector 32 is located on the right of the first connector 32. For this embodiment, the first connector 31 and the second connector 32 are female. The first connector 31 and the second connector 32 are electrically connected to the printed wiring board.

A first opening 35, for exposing the first connector 31 to the outside of the housing 10, is provided in the connector panel 11d at a position facing the first connector 31. A second opening 36, for exposing the second connector 32 to the outside of the housing 10, is provided in the connector panel 11d at a position facing the second connector 32. The first connector 31 and the second connector 32 mounted to the connector panel 11d are contained in the housing 10 such that they are exposed to the outside of the housing 10 through the connector panel 11d (the first opening 35 and the second opening 36 of the connector panel 11d).

External apparatuses, for example, those having the same function but different types of connecting portions are connected to the connectors 31, 32. Hence, in this portable computer 1, it is a prerequisite that the first connector 31 and the second connector 32 are not concurrently used.

In the embodiment, connectors, for example, those that output image signals are used as the first and second connectors 31, 32. More specifically, one of the first and second connectors 31, 32, for example, the first connector 31, is a connector that outputs analog signals, and the second connector 32, which is the other connector, is a connector that outputs digital signals. An RGB connector can be used as such a first connector 31. A DVI connector can be used as such a second connector 32. Alternatively, a connector that outputs digital signals (for example, a DVI connector) and a connector that outputs analog signals (for example, an RGB connector) may be used as the first connector 31 and the second connector 32, respectively. Note that in this portable computer 1, the first connector 31 and the second connector 32 are formed as a single piece, thereby physically connected together and forming a single connector element.

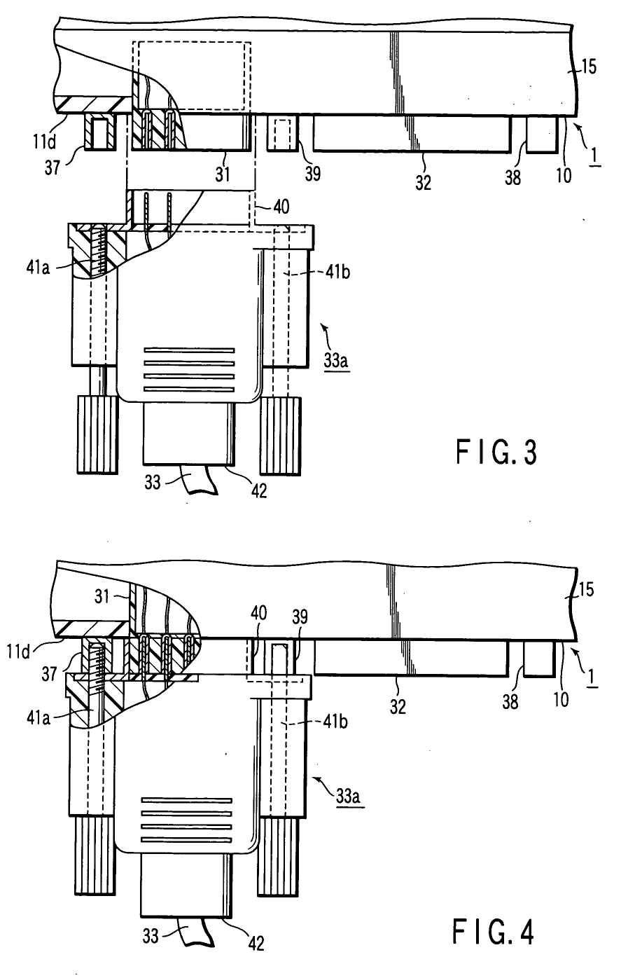

A male first plug 33a (refer to FIGS. 3 and 4) of the first cable 33 can be removably connected to the first connector 31. A male second plug 34a (refer to FIG. 5) of the second cable 34 can be removably connected to the second connector 32. FIG. 1 shows the state where the first plug 33a of the first cable 33 is connected to the first connector 31. In this portable computer 1, an RGB cable having a male RGB plug is used as the first cable 33. A DVI cable having a male DVI plug is used as the second cable 34.

The first plug 33a includes a plug body 40, a pair of screws 41a, 41b, as a pair of fixing members, and a casing 42 (refer to FIGS. 3 and 4). Likewise, the second plug 34a includes a plug body 43, a pair of screws 44a, 44b, as a pair of fixing members, and a casing 45 (refer to FIG. 5). That is to say, when connecting the plugs 33a, 34a to their respective corresponding connectors 31, 32, both of the plugs 33a, 34a are screwed to the housing 10 (such as the connector panel 11d, as the outer wall of the housing 10, or the connectors 31, 32 mounted to the connector panel 11d). Hence, as shown in FIGS. 2 to 5, the housing 10 is provided with screw bosses 37, 38, 39, as fixing member receiving elements.

In this portable computer 1, when connecting the first plug 33a to the first connector 31, the first plug 33a is screwed to the housing 10 using the first screw boss 37 and the third screw boss 39. When connecting the second plug 34a to the second connector 32, the second plug 34a is screwed to the housing 10 using the second screw boss 38 and the third screw boss 39.

The first screw boss 37 is provided to the connector panel 11d of the housing 10 such that it is positioned on the side (the left side in FIGS. 2 to 5) of the first connector 31 opposite to the side on which the second connector 32 is provided. The first screw boss 37 is exposed to the outside of the connector panel 11d. The first screw boss 37 is provided at a position where, among the pair of screws 41a, 41b, the screw 41a on the side (on the left side in FIGS. 2 to 5) opposite to the side on which the second connector 32 is provided, is screwed in, when connecting the first plug 33a to the first connector 31.

The second screw boss 38 is provided to the connector panel 11d of the housing 10 such that it is positioned on the side (the right side in FIGS. 2 to 5) of the second connector 32 opposite to the side on which the first connector 31 is provided. The second screw boss 38 is exposed to the outside of the connector panel 11d. The second screw boss 38 is provided at a position where, among the pair of screws 44a, 44b, the screw 44a on the side (the right side in FIGS. 2 to 5) opposite to the side on which the first connector 31 is provided, is screwed in, when connecting the second plug 34a to the second connector 32.

The third screw boss 39 is provided to the connector panel 11d of the housing 10 such that it is positioned between the first connector 31 and the second connector 32. The third screw boss 39 is exposed to the outside of the connector panel 11d. The third screw boss 39 is provided at a position where, among the pair of screws 41a, 41b, the other screw 41b on the side (the right side in FIGS. 2 to 5) on which the second connector 32 is provided, is screwed in, when connecting the first plug 33a to the first connector 31, and where, among the pair of screws 44a, 44b, the other screw 44b on the side (the left side in FIGS. 2 to 5) on which the first connector 31 is provided, is screwed in, when connecting the second plug 34a to the second connector 32. The screw bosses 37, 38, 39 protrude from the outer surface of the housing 10.

The first to third screw bosses 37, 38, 39, and the first and second connectors 31, 32, may all be in one piece. In that instance, for example, openings are formed to expose the first to third screw bosses 37, 38, 39, in the connector panel 11d and expose the first to third screw bosses 37, 38, 39 to the outside of the housing 10 through the connector panel 11d.

In the embodiment, each of the plugs 33a, 34a has a symmetrical outer shape, as shown in FIGS. 3 to 5. In that instance, the first, second and third screw bosses 37, 38, 39 are positioned such that the distance L1 between the center O1 of the third screw boss 39 and the center O4 of the first connector 31 equals the distance L2 between the center O2 of the first screw boss 37 and the center O4 of the first connector 31, and the distance L3 between the center O1 of the third screw boss 39 and the center O5 of the second connector 32 equals the distance L4 between the center O3 of the second screw boss 38 and the center O5 of the second connector 32, as shown in FIG. 2.

The above-described portable computer 1 permits connection of either an external apparatus that receives analog image signals and display images, or an external apparatus that receives digital image signals and display images, as an extension apparatus.

When an external apparatus that receives analog image signals and displays images is to be used, an analog external device that displays images (not shown) is connected to the first connector 31 via the first cable 33, as shown in FIGS. 3 and 4. In doing so, the first plug 33a is secured to the housing 10 with the screws 41a, 41b, using the first screw boss 37 and the third screw boss 39. Thus, the first plug 33a is fixed to the housing 10.

On the other hand, when an external apparatus that receives digital image signals and displays images is to be used, a digital external apparatus that displays images (not shown) is connected to the second connector 32 via the second cable 34, as shown in FIG. 5. In doing so, the second plug 34a is secured to the housing 10 with the screws 44a, 44b, using the second screw boss 38 and the third screw boss 39. Thus, the second plug 34a is secured to the housing 10.

As described above, the portable computer 1 of this embodiment includes the first screw boss 37, as the first fixing member receiving element that fixes (screws together with) one screw 41a among the pair of screws 41a, 41b of the first plug 33a; the second screw boss 38, as the second fixing member receiving element that fixes (screws together with) one screw 44a among the pair of screws 44a, 44b of the second plug 34a; and the third screw boss 39, as the third fixing member receiving element that fixes (screws together with) either the other screw 41b among the pair of screws 41a, 41b of the first plug 33a or the other screw 44b among the pair of screws 44a, 44b of the second plug 34a at a time.

Hence, when connecting the first plug 33a to the first connector 31, the first plug 33a can be fixed to the housing 10 using the first screws boss 37 and the third screw boss 39. On the other hand, when connecting the second plug 34a to the second connector 32, the second plug 34a can be fixed to the housing 10 using the second screw boss 38 and the third screw boss 39.

In other words, in the embodiment, only one screw boss 39 is provided between the connectors 31, 32, and the screw 39 is used for fixing both the first plug 33a and the second plug 34a to the housing 10 or the connectors 31, 32. Therefore, the space between the first connector 31 and the second connector 32 can be made smaller than before. In other words, the first connector 31 and the second connector 32 can be placed at a higher density than before, and consequently, the space occupied by the connectors can be reduced.

In addition, as a result of that, the portable computer 1 can be made smaller without reducing the number of mounted connectors or, alternatively, the number of mounted connectors can be increased without making the portable computer 1 larger.

Moreover, in the portable computer 1, the first connector 31 is one piece with the second connector 32. Hence, the assembly, when these connectors 31, 32 are mounted to the housing 10, is easy.

Note that the first connector 31 and the second connector 32 may be separate pieces. In that instance, already available connectors can be used, without any modification, as the first connector 31 and the second connector 32.

In the present invention, the fixing members and the fixing member receiving elements are not limited to screws and screw bosses. There is, for example, a kind of plugs that printer cables, etc., have, which are provided with engagement elements as fixing members. In that instance, the first to third screw bosses 37, 38, 39 can be replaced with first to third engagement members, for example, clip-like first to third engagement metal members, and use them instead as the fixing member receiving elements. If the first connector 31 and the second connector 32 are to be mounted to the inner surface of the connector panel 11d, as in the present embodiment, the first to third engagement members are provided to the outer surface of the connector panel 11d or to the connectors 31, 32 such that they are exposed to the outside of the housing 10.

Further, in the present invention, the first connector 31 and the second connector 32 are not limited to the connectors used in the embodiment. The first connector 31 and the second connector 32 are applicable not only to connectors that output image signals but also to various connectors. In addition, in the present invention, the first connector 31 and the second connector 32 may both be connectors that output analog signals, or alternatively, digital signals, although in the embodiment, one of the first and second connectors 31, 32 is a connector that outputs analog signals and the other one of the first and second connectors 31, 32 is a connector that outputs digital signals.

In the embodiment, the first connector 31 and the second connector 32 are mounted to the connector panel 11d, which serves as the rear wall of the outer wall 11 of the housing 10. However, it is contemplated that the first connector 31 and the second connector 32 do not necessarily need to be mounted to the connector panel 11d.

The electronic apparatus according to the present invention is not limited to a portable computer with a keyboard and a display unit. The present invention can be implemented in the same manner also in, for example, a pen-input type computer that uses a tablet instead of a keyboard. Therefore, while certain exemplary embodiments of the invention have been described and shown in the accompanying drawings, it is to be understood that such embodiments are merely illustrative of and not restrictive on the broad aspects of various embodiments of the invention.

What is claimed is:

1. An electronic apparatus comprising:
a housing;
a first connector provided to the housing, a first plug, including a plug body and a pair of fixing members provided on both sides of the plug body, being removably connected to the first connector;
a second connector provided to the housing, a second plug, including a plug body and a pair of fixing members provided on both sides of the plug body, being removably connected to the second connector;
a first fixing member receiving element provided to the housing on a side of the first connector opposite to a side on which the second connector is provided, the first fixing member receiving element adapted to receive a first fixing member among the pair of fixing members of the first plug;
a second fixing member receiving element provided to the housing on a side of the second connector opposite to a side on which the first connector is provided, the second fixing member receiving element adapted to receive a first fixing member among the pair of fixing members of the second plug; and
a third fixing member receiving element provided to the housing between the first connector and the second connector, the third fixing member receiving element adapted to receive either (1) a second fixing member among the pair of fixing members of the first plug or (2) a second fixing member among the pair of fixing members of the second plug.

2. The electronic apparatus according to claim 1, wherein the first, second and third fixing member receiving elements are positioned such that a distance between a center of the third fixing member receiving element and a center of the first connector is substantially equal to a distance between a center of the first fixing member receiving element and the center of the first connector, and a distance between the center of the third fixing member receiving element and a center of the second connector is substantially equal to a distance between a center of the second fixing member receiving element and the center of the second connector.

3. The electronic apparatus according to claim 1, wherein the first and second connectors are connectors that output image signals.

4. The electronic apparatus according to claim 1, wherein one of the first and second connectors is a connector that outputs analog signals, and another one of the first and second connectors is a connector that outputs digital signals.

5. The electronic apparatus according to claim 1, wherein the first fixing member receiving element is a screw boss.

6. An electronic apparatus comprising:
a housing having an outer wall;
a first connector contained in the housing, the first connector being exposed to the outside through the outer wall, and a first plug, including a plug body and a pair of screws provided on both sides of the plug body, being removably connected to the first connector;
a second connector contained in the housing, the second connector being exposed to the outside through the outer wall, and a second plug, including a plug body and a pair of screws provided on both sides of the plug body, being removably connected to the second connector;
a first screw boss positioned on a side of the first connector opposite to a side on which the second connector is provided, the first screw boss being exposed through the outer wall, and adapted to receive a first screw among the pair of screws of the first plug;
a second screw boss positioned on a side of the second connector opposite to a side on which the first connector is provided, the second screw boss being exposed through the outer wall, and adapted to receive a first screw among the pair of screws of the second plug; and
a third screw boss positioned between the first connector and the second connector, the third screw boss being exposed through the outer wall, and adapted to receive a second screw among the pair of screws of the first plug and a second screw among the pair of screws of the second plug.

7. The electronic apparatus according to claim 6, wherein the first and second connectors are connectors that output image signals.

8. The electronic apparatus according to claim 6, wherein one of the first and second connectors is a connector that outputs analog signals, and another one of the first and second connectors is a connector that outputs digital signals.

9. The electronic apparatus according to claim 6, wherein the first connector and the second connector are physically connected together and form a single connector element.

10. An electronic apparatus comprising:
a housing including a connector panel;
a first connector mounted to the connector panel, a first plug, including a plug body and a pair of engagement elements each provided on opposite sides of the plug body, being removably connected to the first connector;
a second connector mounted to the connector panel, a second plug, including a plug body and a pair of engagement elements each provided on an opposite side of the plug body, being removably connected to the second connector;
a first engagement member provided to the connector panel on a side of the first connector opposite to a side on which the second connector is provided, the first engagement member adapted to engage with a first engagement element among the pair of engagement elements of the first plug;
a second engagement member provided to the connector panel on a side of the second connector opposite to a side on which the first connector is provided, the second engagement member adapted to engage with a first engagement element among the pair of engagement elements of the second plug; and
a third engagement member provided to the connector panel between the first connector and the second connector, the third engagement member adapted to engage with one of a second engagement element among the pair of engagement elements of the first plug and a second engagement element among the pair of engagement elements of the second plug.

11. The electronic apparatus according to claim 10, wherein the first and second connectors are connectors that output image signals.

12. The electronic apparatus according to claim 10, wherein one of the first and second connectors is a connector that outputs analog signals, and another one of the first and second connectors is a connector that outputs digital signals.

13. The electronic apparatus according to claim 10, wherein the first connector and the second connector are physically connected together and form a single connector element.

14. An electronic apparatus comprising:
a housing including a side wall having a plurality of openings;
a first connector protruding from a first opening of the plurality of openings;
a second connector protruding from a second opening of the plurality of openings; and
a plurality of fixing member receiving elements having a single fixing member receiving element positioned on each side of the first connector and the second connector so that only one fixing member receiving element is positioned between the first connector and the second connector.

15. The electronic apparatus according to claim 14 is a portable computer.

16. The electronic apparatus according to claim 14, wherein a fixing member receiving element positioned between the first connector and the second connector is adapted to either (1) receive a fixing member from a plug attached to the first connector, or (2) receive a fixing member from a plug attached to the second connector.

17. The electronic apparatus according to claim 14, wherein a third fixing member receiving element of the plurality of fixing member receiving elements is positioned such that a distance between the third fixing member receiving element and a center of the first connector is substantially equal to a distance between a first fixing member receiving element of the plurality of fixing member receiving elements and the center of the first connector, and a distance between the third fixing member receiving element and a center of the second connector is substantially equal to a distance between a second fixing member receiving element of the plurality of fixing member receiving elements and the center of the second connector.

18. The electronic apparatus according to claim 14, wherein the first connector to output analog signals and the second connector to output digital signals.
